(19) United States
(12) Patent Application Publication
(10) Pub. No.: US 2025/0362492 A1
(43) Pub. Date: Nov. 27, 2025

(54) MEMS MIRROR DRIVING CIRCUIT, SCANNING PROJECTION SYSTEM, AND MEMS MIRROR DRIVING METHOD

(71) Applicant: Stanley Electric Co., Ltd., Tokyo (JP)

(72) Inventor: Makoto YONEYAMA, Tokyo (JP)

(73) Assignee: Stanley Electric Co., Ltd., Tokyo (JP)

(21) Appl. No.: 19/212,749

(22) Filed: May 20, 2025

(30) Foreign Application Priority Data
May 21, 2024 (JP) 2024-082785

(51) Int. Cl. G02B 26/08; G02B 26/10

(52) U.S. Cl. CPC G02B 26/0858; G02B 26/101

(57) ABSTRACT

A MEMS mirror driving circuit includes a driving circuit that receives MEMS driving data from a control circuit and outputs, to a MEMS mirror device, a driving signal generated based on the MEMS driving data; and a safety circuit that receives status information and the MEMS driving data from the control circuit and determines whether data communication with the control circuit is normal, in a case in which the data communication is normal, acquires driving signal information for generating, based on the status information and the MEMS driving data, an alternate driving signal that serves as an alternative to the driving signal and, in a case in which the data communication is not normal, outputs, instead of the driving signal, the alternate driving signal.

### CROSS-REFERENCE TO RELATED APPLICATION

This application claims the benefit of Japanese Patent Application No. 2024-082785, filed on May 21, 2024, the entire disclosure of which is incorporated by reference herein.

### FIELD OF THE INVENTION

The present application relates to a MEMS mirror driving circuit, a scanning projection system, and a MEMS mirror driving method.

### BACKGROUND OF THE INVENTION

In the related art, illumination devices and video projection devices are known that project a video by scanning, using a micro electromechanical systems (MEMS) mirror, light emitted from a light source. In such devices, it is necessary to confirm that the MEMS mirror is operating appropriately. For example, Japanese Patent No. 7343410 describes an illumination device and the like that includes a light polarizer capable of detecting operations of a MEMS mirror by a simple configuration.

### SUMMARY OF THE INVENTION

A MEMS mirror driving circuit according to the present disclosure includes:
a driving circuit that receives MEMS driving data from a control circuit and outputs, to a MEMS mirror device, a driving signal generated based on the MEMS driving data; and
a safety circuit that receives status information and the MEMS driving data from the control circuit and determines whether data communication with the control circuit is normal, in a case in which the data communication is normal, acquires driving signal information for generating, based on the status information and the MEMS driving data, an alternate driving signal that serves as an alternative to the driving signal and, in a case in which the data communication is not normal, outputs, instead of the driving signal, the alternate driving signal generated based on the driving signal information to the MEMS mirror device.

### BRIEF DESCRIPTION OF DRAWINGS

A more complete understanding of this application can be obtained when the following detailed description is considered in conjunction with the following drawings, in which:

FIG. 1 is a drawing illustrating a configuration example of a scanning projection system according to Embodiment 1;

FIG. 2 is a drawing illustrating a configuration example of the internal blocks of a safety circuit according to Embodiment 1;

FIG. 3 is a drawing illustrating an example of a waveform of a driving voltage signal of a MEMS mirror from when scanning a laser in a horizontal direction;

FIG. 4 is a drawing illustrating an example of a waveform of the driving voltage signal of the MEMS mirror from when scanning the laser in a vertical direction;

FIG. 5 is an example of a flowchart of status information receiving processing according to Embodiment 1;

FIG. 6 is an example of a flowchart of timed-out time processing according to Embodiment 1;

FIG. 7 is an example of a flowchart of data-interrupted time processing according to Embodiment 1;

FIG. 8 is a drawing for explaining a stopping sequence of the MEMS mirror;

FIG. 9 is a drawing for explaining an upper peak value and a lower peak value for a case of bipolar driving;

FIG. 10 is a drawing for explaining an upper peak value for a case of unipolar driving; and

FIG. 11 is an example of a flowchart of driving data storing processing according to Embodiment 2.

### DETAILED DESCRIPTION OF THE INVENTION

Hereinafter, embodiments of the present disclosure are described while referencing the drawings Note that, in the drawings, identical or corresponding components are denoted with the same reference numerals.

### Embodiment 1

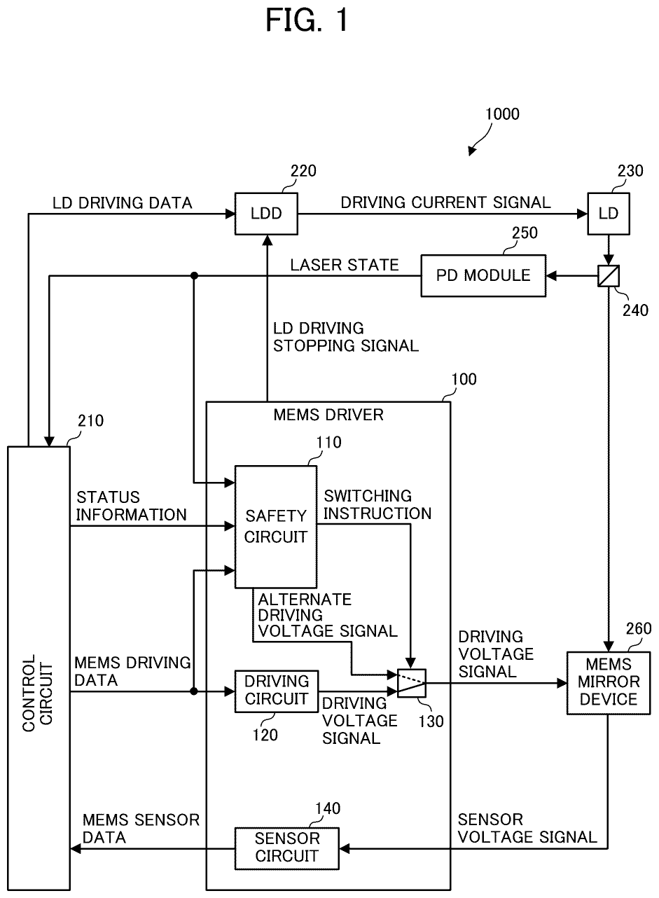

As illustrated in FIG. 1, a scanning projection system 1000 according to Embodiment 1 of the present disclosure includes a MEMS driver 100, a control circuit 210, a laser diode driver (LDD) 220, a laser diode (LD) 230, a beam splitter 240, a photo-diode (PD) module 250, and a MEMS mirror device 260.

The MEMS driver 100 is a MEMS mirror driving circuit that drives the MEMS mirror device 260 by digital to analog (D/A) converting MEMS driving data received from the control circuit 210 to a driving voltage signal and outputting the converted driving voltage signal. More specifically, as illustrated in FIG. 1, the MEMS driver 100 includes a safety circuit 110, a driving circuit 120, a switching switch 130, and a sensor circuit 140. Note that the MEMS driving data is digital data obtained by sampling, at a predetermined sampling frequency, the driving voltage signal that causes the MEMS mirror to oscillate, and is output every sampling cycle from the control circuit 210.

The safety circuit 110 is a circuit that, when the MEMS driving data cannot be normally received from the control circuit 210, instead of the driving circuit 120, outputs an alternate driving voltage signal (alternate driving signal) that serves as an alternative for the driving voltage signal (driving signal). The safety circuit 110 is described in detail later.

The driving circuit 120 D/A converts the MEMS driving data received from the control circuit 210 to generate the driving voltage signal, and outputs the generated driving voltage signal to the MEMS mirror device 260.

The switching switch 130 is a switch for switching whether to output the driving voltage signal from the driving circuit 120 to the MEMS mirror device 260 or to output the alternate driving voltage signal from the safety circuit 110 to the MEMS mirror device 260.

The sensor circuit 140 receives a sensor voltage signal output from the MEMS mirror device 260, and outputs MEMS sensor data to the control circuit 210. Note that the sensor circuit 140 is a circuit that corresponds to the sensor signal processor 103 disclosed in Patent Literature 1 and, although not an essential circuit of the MEMS driver 100, due to the sensor circuit 140 outputting the MEMS sensor data, the control circuit 210 can correct a driving timing of the MEMS mirror device 260.

The control circuit 210 controls the operations of the entire scanning projection system 1000, and synchronizes the driving timings of the MEMS mirror device 260 and the LD 230. Specifically, on the basis of data of a video to be projected, the control circuit 210 outputs the MEMS driving data to the MEMS driver 100 and outputs LD driving data to the LDD 220. Additionally, the control circuit 210 also outputs, to the MEMS driver 100, status information that is used when determining whether the data communication between the control circuit 210 and the MEMS driver 100 is normal. The status information is described later. Note that, as described above, the control circuit 210 may correct the driving timing of the MEMS mirror device 260 using the MEMS sensor data received from the MEMS driver 100.

The LDD 220 outputs, on the basis of the LD driving data received from the control circuit 210, a driving current signal for driving the LD 230.

The LD 230 emits a visible-light laser of one or more colors among red, green, and blue (RGB). An output level of the laser emitted by the LD 230 changes on the basis of the driving current signal received from the LDD 220.

The beam splitter 240 splits the laser output by the LD 230 into two beams. As a result, the laser output by the LD 230 enters not only the MEMS mirror device 260, but also the PD module 250.

The PD module 250 measures the amount of light of the laser output by the LD 230, and outputs, to the control circuit 210 and the MEMS driver 100, the amount of light of the laser (emission state) as information about the laser state (emission state data). Note that, in the present embodiment, the LD 230 is used as the light source, but the light source is not limited to the LD 230 and a configuration is possible in which the PD module 250 measures the amount of light of a desired light source and outputs that emission state data to the control circuit 210 and the MEMS driver 100.

The MEMS mirror device 260 includes an actuator constituted by a piezoelectric element, and a MEMS mirror that is oscillated by this actuator. The magnitude of the oscillation (angle of rotation) of the MEMS mirror is based on the magnitude of the driving voltage signal received from the MEMS driver 100. The MEMS mirror device 260 projects a video on a predetermined projection surface by oscillating the mirror while reflecting the laser output by the LD 230 by the mirror to perform raster scanning.

Typically, in raster scanning, main scanning performed by oscillating the MEMS mirror in the horizontal direction by resonant driving and sub scanning performed by oscillating the MEMS mirror in the vertical direction by non-resonant driving are performed in parallel. The driving voltage signal that causes the MEMS mirror to oscillate is obtained by D/A converting the MEMS driving data and, as such, the control circuit 210 outputs, in parallel and as the MEMS driving data, each of horizontal direction MEMS driving data for generating the driving voltage signal that causes the MEMS mirror to oscillate in the horizontal direction and vertical direction MEMS driving data for generating the driving voltage signal that causes the MEMS mirror to oscillate in the vertical direction.

Note that, in order to perform processing in which the control circuit 210 described above uses the MEMS sensor data to correct the driving timing of the MEMS mirror device 260, the MEMS mirror device 260 must include a sensor for detecting the movement of the MEMS mirror and, in such a case, a sensor voltage signal is output on the basis of the value detected by the sensor.

Next, the safety circuit 110 is described in detail. The safety circuit 110 is a circuit that, when the MEMS driving data can be normally received from the control circuit 210, stores that data and, when the MEMS driving data can no longer be normally received, outputs the driving voltage signal (alternate driving voltage signal) on the basis of the stored data. The data to be stored may be the MEMS driving data itself but, in the present embodiment, the peak values (upper peak value and lower peak value) and the cycles (rise period and fall period) are stored, and a waveform of the driving voltage signal is reproduced on the basis of the peak values and cycles.

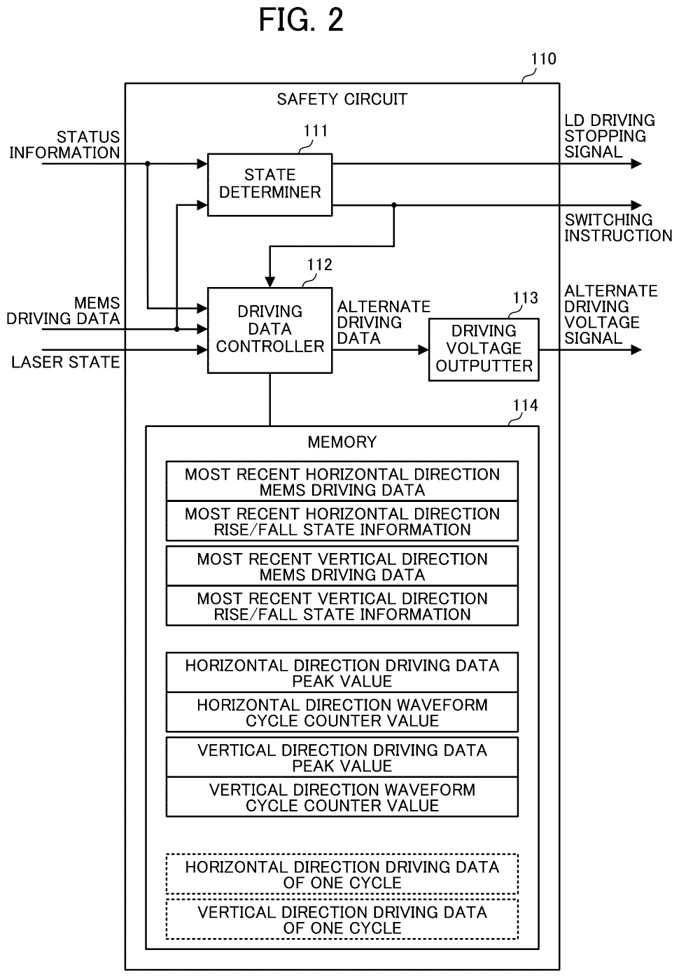

As illustrated in FIG. 2, the safety circuit 110 includes a state determiner 111, a driving data controller 112, a driving voltage outputter 113, and a memory 114.

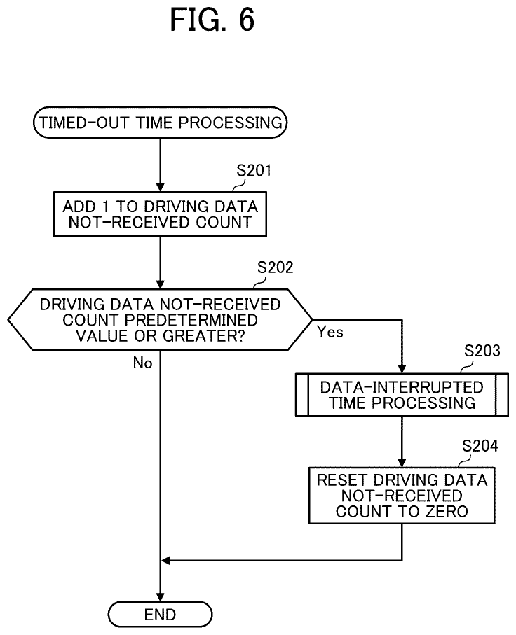

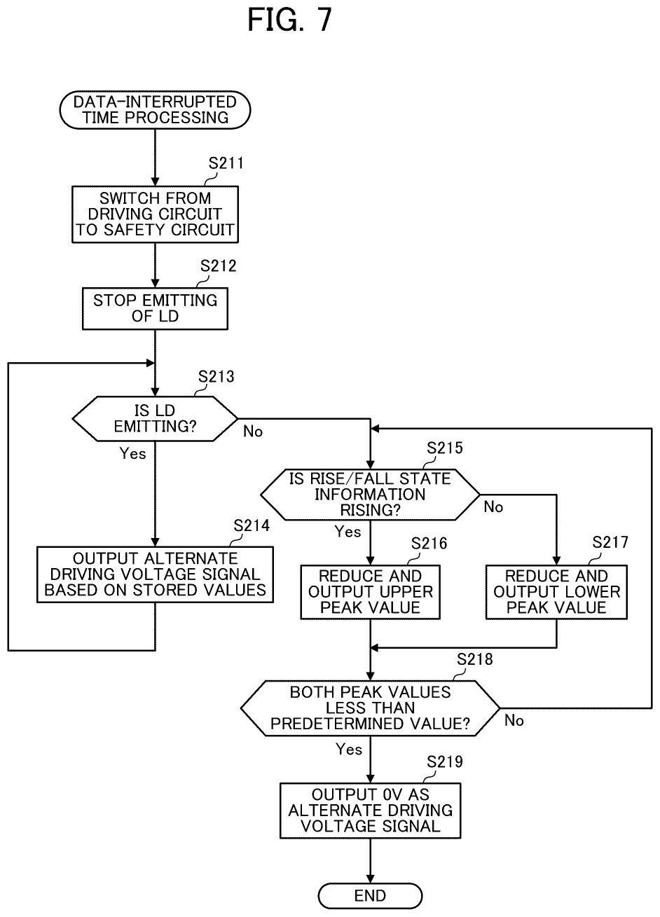

The state determiner 111 monitors, by timed-out time processing (FIG. 6) and the like described later, a reception state of the data (the MEMS driving data and the status information) from the control circuit 210, and determines whether the data communication with the control circuit 210 is normal. When the state determiner 111 determines that the data communication with the control circuit 210 is abnormal, the state determiner 111 instructs (by data-interrupted time processing (FIG. 7) described later) so as to output the MEMS driving data to the driving data controller 112, issues a switching instruction to the switching switch 130 so as to output the alternate driving voltage signal from the safety circuit 110, and further outputs an LD driving stopping signal to the LDD 220 in order to stop the driving of the LD 230.

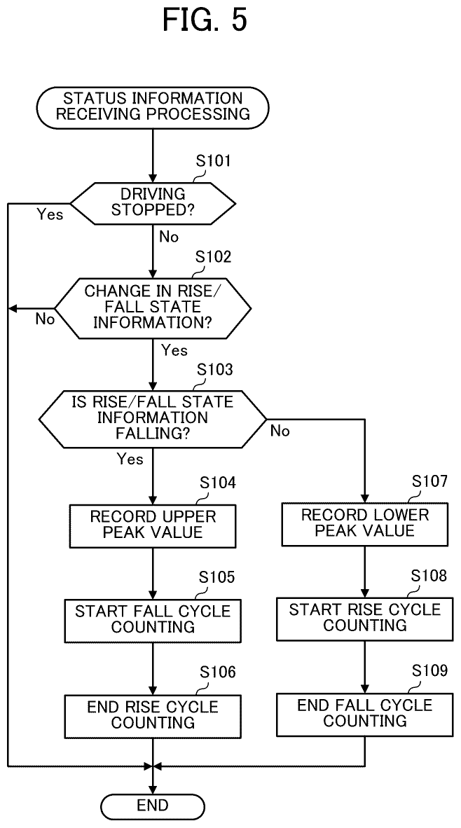

The driving data controller 112 stores, in the memory 114 and by status information receiving processing (FIG. 5) described later, driving characteristics data (the peak values and cycles) indicating characteristics of the MEMS driving data received from the control circuit 210. Additionally, the driving data controller 112 stores the normally received MEMS driving data and rise/fall state information of the status information in the memory 114 during the period in which the driving state information of the status information is “driving”, thereby making it possible to reference the most recent values of the rise/fall state information and the MEMS driving data.

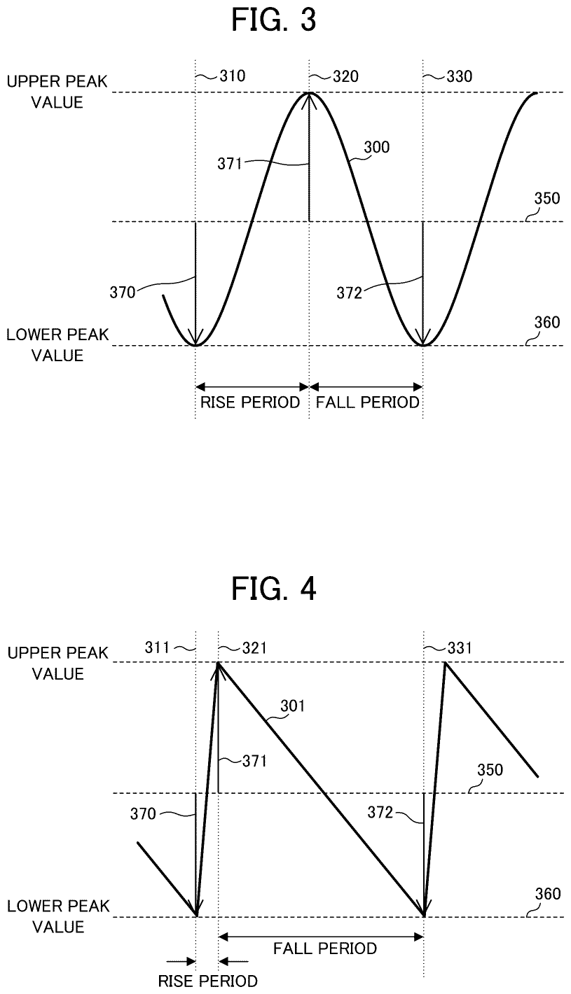

FIG. 3 illustrates an example of a waveform 300 (example of a sine wave) of the driving voltage signal from when the MEMS mirror device 260 is resonantly driven to cause the output of the LD 230 to scan in the horizontal direction. The MEMS driving data for causing such driving of the MEMS mirror is a value obtained by sampling the waveform 300 at a predetermined sampling frequency but, since this sampling frequency is extremely high, when plotting the MEMS driving data, a waveform 300 is obtained that is substantially the same as when plotting the driving voltage signal.

As is clear from FIG. 3, there are lower peak values 370, 372 and an upper peak value 371 in the waveform 300 of the MEMS driving data. The period (amount of time) from a timing 310 at which the MEMS driving data is the lower peak value 370 to a timing 320 at which the MEMS driving data is the upper peak value 371 is a rise period, and the period (amount of time) from the timing 320 at which the MEMS driving data is the upper peak value 371 to a timing 330 at which the MEMS driving data is the lower peak value 372 is a fall period. Note that, in the driving of the MEMS mirror device 260, there are bipolar driving (driving in which the driving voltage signal takes positive and negative values) and unipolar driving (driving in which the driving voltage signal is always greater than or equal to 0V). The lower peak values 370, 372 and the upper peak value 371 illustrated in FIG. 3 are for bipolar driving (a dashed line 350 is the 0V position). The lower peak value is 0V in the case of unipolar driving (a dashed line 360 is the 0V position).

FIG. 4 illustrate an example (example of a ramp wave) of a waveform 301 of the driving voltage signal from when the MEMS mirror device 260 is non-resonantly driven to scan the output of the LD 230 in the vertical direction. As described above, when plotting the MEMS driving data for causing such driving of the MEMS mirror, the waveform 301, which is substantially the same as when plotting the driving voltage signal, is obtained.

As is clear from FIG. 4, in the case of non-resonant driving as well, the lower peak values 370, 372 and the upper peak value 371 are present in the waveform 301 of the MEMS driving data. The period (amount of time) from a timing 311 at which the MEMS driving data is the lower peak value 370 to a timing 321 at which the MEMS driving data is the upper peak value 371 is the rise period, and the period (amount of time) from the timing 321 at which the MEMS driving data is the upper peak value 371 to a timing 331 at which the MEMS driving data is the lower peak value 372 is the fall period. Note that, the lower peak values 370, 372 and the upper peak value 371 illustrated in FIG. 4 are also for bipolar driving (the dashed line 350 is the 0V position). The lower peak value is 0V in the case of unipolar driving (the dashed line 360 is the 0V position).

As a result of the status information receiving processing (FIG. 5) described later and as the driving characteristics data indicating the characteristics of the horizontal direction MEMS driving data, the driving data controller 112 stores, in the memory 114, the upper peak value 371 and the lower peak value 372 illustrated in FIG. 3 as the peak values of the horizontal direction driving data, and stores, in the memory 114, the rise period and the fall period illustrated in FIG. 3 as horizontal direction waveform cycle counter values. Likewise, as the driving characteristics data indicating the characteristics of the vertical direction MEMS driving data, the driving data controller 112 stores, in the memory 114, the upper peak value 371 and the lower peak value 372 illustrated in FIG. 4 as the peak values of the vertical direction driving data, and stores, in the memory 114, the rise period and the fall period illustrated in FIG. 4 as vertical direction waveform cycle counter values. The driving characteristics data is data that is needed for the safety circuit 110 to generate the alternate driving voltage signal, and is also called “driving signal information.”

Next, the driving data controller 112 generates alternate MEMS driving data (alternate driving data) on the basis of the driving characteristics data stored in the memory 114. Additionally, the driving data controller 112 references the laser state and, if the laser is not being output, changes the alternate driving data so as to gradually reduce the amplitude of and stop the oscillating of the MEMS mirror in accordance with an amount of attenuation corresponding to the characteristics of the MEMS mirror. When the laser is being output, the driving data controller 112 outputs the generated alternate driving data without modification, thereby maintaining the oscillating of the MEMS mirror.

The driving voltage outputter 113 outputs the alternate driving voltage signal on the basis of the value of the alternate driving data output by the driving data controller 112. In actuality, the driving voltage outputter 113 may be the same circuit as the driving circuit 120.

Accordingly, a configuration is possible in which, instead of the safety circuit 110 including the driving voltage outputter 113 (outputting the alternate driving voltage signal), the safety circuit 110 is configured to output the alternate driving data (without including the driving voltage outputter 113), in FIG. 1, the switching switch 130 is disposed on the input side instead of on the output side of the driving circuit 120 and, the data to be input into the driving circuit 120 is switched, in accordance with the switching instruction, to the MEMS driving data from the control circuit 210 or to the alternate driving data from the safety circuit 110.

In the present embodiment, an example is described in which the driving characteristics data includes information related to the peak values and the cycles of the MEMS driving data, but the driving data controller 112 can, from these pieces of information, generate and output MEMS driving data (alternate driving data) of a desired waveform shape (sine wave, square wave, ramp wave (triangle wave, sawtooth wave), or the like) in accordance with the use or the like. Additionally, while described later as Embodiment 2, a configuration is possible in which, when it is desired to more accurately reproduce the MEMS driving data, the driving data controller 112 stores one cycle of each of the horizontal direction and the vertical direction MEMS driving data (horizontal direction driving data of one cycle and vertical direction driving data of one cycle) in the memory 114.

Specifically, the safety circuit 110 according to Embodiment 1 acquires the driving characteristics data (the peak values and cycles) as the driving signal information, and the safety circuit 110 according to Embodiment 2 described later acquires driving data of one cycle that is the MEMS driving data of one cycle as the driving signal information. When the MEMS driver 100 cannot normally receive the MEMS driving data from the control circuit 210, the safety circuit 110 generates the alternate driving voltage signal from the alternate driving data generated on the basis of the driving signal information, and outputs the generated alternate driving voltage signal to the MEMS mirror device 260.

The status information is data that indicates the state that the control circuit 210 is controlling, and includes the rise/fall state information and the driving state information. The rise/fall state information indicates whether the MEMS driving data is rising or falling (rise or fall). For example, in FIG. 3, the rise/fall state information is “rising” if in the rise period, and the rise/fall state information is “falling” if in the fall period. Additionally, the driving state information indicates the driving state of the MEMS mirror (being driven or stopped). For example, the driving state information is “being driven” if the control circuit 210 is outputting the MEMS driving data every sampling cycle, and the driving state information is “stopped” if the control circuit 210 is not outputting the MEMS driving data.

Each of the rise/fall state information and the driving state information can be expressed by one bit and, as such, the status information can be expressed by two bits. However, the status information exists for every type of the MEMS driving data and, as such, in the present embodiment, status information corresponding to the horizontal direction MEMS driving data (horizontal direction status information) and status information corresponding to the vertical direction MEMS driving data (vertical direction status information) exist. In the present embodiment, the control circuit 210 outputs the status information at the same timing (the predetermined sampling cycle) as the MEMS driving data. However, a configuration is possible in which the status information is output only when a value has changed.

While not illustrated in the drawings, as described above, during the period in which the driving state information of the status information is “being driven”, the driving data controller 112 stores the most recent MEMS driving data and the most recent rise/fall state information in the memory 114 every time the MEMS driving data and the rise/fall state information of the status information are normally received. However, since, as described above, there are two types of the MEMS driving data and the status information, namely the horizontal direction and the vertical direction types, as illustrated in FIG. 2, each of most recent horizontal direction MEMS driving data, most recent horizontal direction rise/fall state information, most recent vertical direction MEMS driving data, and most recent vertical direction rise/fall state information is stored in the memory 114.

Next, the status information receiving processing executed when the safety circuit 110 receives the status information is described while referencing FIG. 5. However, since, as described above, there are two types of the status information, namely the horizontal direction status information and the vertical direction status information, in actuality, each of two types of processing, namely status information receiving processing for when the horizontal direction status information is received (horizontal direction status information receiving processing) and status information receiving processing for when the vertical direction status information is received (vertical direction status information receiving processing) is executed.

Firstly, the safety circuit 110 determines whether the driving of the MEMS mirror is stopped, that is, whether the driving state information included in the status information indicates “stopped” (step S101). When the driving of the MEMS mirror is stopped (step S101; Yes), the status information receiving processing is ended. When the driving of the MEMS mirror is not stopped (step S101; No), the safety circuit 110 determines whether the rise/fall state information included in the status information has changed, that is, whether the rise/fall state information has changed from rising to falling or from falling to rising (step S102).

When the rise/fall state information has not changed (step S102; No), the status information receiving processing is ended. When the rise/fall state information has changed (step S102; Yes), the safety circuit 110 determines whether the rise/fall state information is falling (step S103).

When the rise/fall state information is falling (step S103; Yes), the safety circuit 110 records the MEMS driving data acquired immediately before in the memory 114 as the upper peak value (horizontal direction upper peak value or vertical direction upper peak value) (step S104). Then, the safety circuit 110 starts counting the fall cycle (step S105). Specifically, a counter (fall counter) that counts the fall cycle is reset to zero. Then, the rise cycle counting is ended (step S106). Specifically, the value (horizontal direction rise counter value or vertical direction rise counter value) of the counter (rise counter) that had been counting the rise cycle is recorded in the memory 114. Then, the safety circuit 110 ends the status information receiving processing.

Meanwhile, when the rise/fall state information is rising (step S103; No), the safety circuit 110 records the MEMS driving data acquired immediately before in the memory 114 as the lower peak value (horizontal direction lower peak value or vertical direction lower peak value) (step S107). Then, the safety circuit 110 starts counting the rise cycle (step S108). Specifically, a counter (rise counter) that counts the rise cycle is reset to zero. Then, the fall cycle counting is ended (step S109). Specifically, the value (horizontal direction fall counter value or vertical direction fall counter value) of the counter (fall counter) that had been counting the fall cycle is recorded in the memory 114. Then, the safety circuit 110 ends the status information receiving processing.

As a result of the status information receiving processing described above, the most recent driving characteristics data (the peak values and the cycles) are stored in the memory 114.

Next, timed-out time processing that is executed when the safety circuit 110 detects a time out of the MEMS driving data is described while referencing FIG. 6. Here, a time out of the MEMS driving data occurs when the MEMS driving data cannot be received within a predetermined period (for example, an amount of time that is two-times the sampling cycle of the MEMS driving data). A timer for detecting the time out is configured to reset upon receipt of the MEMS driving data, and the timed-out time processing is not executed while the MEMS driving data can be normally received.

Note that, as described above, since there are two types of the MEMS driving data, namely the horizontal direction MEMS driving data and the vertical direction MEMS driving data, in actuality, each of two types of processing, namely timed-out time processing for when the horizontal direction MEMS driving data times out (horizontal direction timed-out time processing) and timed-out time processing for when the vertical direction MEMS driving data times out (vertical direction timed-out time processing) is executed. However, it is thought that when a time out occurs, the data communication between the control circuit 210 and the MEMS driver 100 is not normal (an abnormality is occurring) and, as such, it is thought that, in most cases, when one of the timed-out time processings is executed, the other timed-out time processing will also be executed.

Firstly, the safety circuit 110 adds 1 to a driving data not-received count (step S201). Note that the driving data not-received count is reset to zero when the MEMS driver 100 is started up. Then, the safety circuit 110 determines whether the driving data not-received count is greater than or equal to a predetermined value (for example, 3 times) (step S202).

When the driving data not-received count is less than the predetermined value (step S202; No), the timed-out time processing is ended. When the driving data not-received count is greater than or equal to the predetermined value (step S202; Yes), the safety circuit 110 executes the data-interrupted time processing described later (step S203), resets the driving data not-received count to zero (step S204), and ends the timed-out time processing.

As a result of the timed-out time processing described above, whether the data communication between the control circuit 210 and the safety circuit 110 is normal is monitored and, when not normal (when abnormal), the data-interrupted time processing described later is executed.

Next, the data-interrupted time processing is described while referencing FIG. 7. This processing is called from step S203 of the timed-out time processing (FIG. 6) and, as such, as with the timed-out time processing, each of two types of processings, namely data-interrupted time processing for when the horizontal direction MEMS driving data times out (horizontal direction data-interrupted time processing) and data-interrupted time processing for when the vertical direction MEMS driving data times out (vertical direction data-interrupted time processing), is executed.

Firstly, the safety circuit 110 switches the circuit, of the output source of the driving voltage signal that the MEMS driver 100 outputs to the MEMS mirror device 260, from the driving circuit 120 to the safety circuit 110 (step S211). Specifically, the state determiner 111 instructs the driving data controller 112 to output the alternate driving data, and issues a switching instruction to the switching switch 130 to output the alternate driving voltage signal. At this time, the driving data controller 112 ascertains the timing at which the data communication with the control circuit 210 became abnormal on the basis of the most recent MEMS driving data and rise/fall state information that was normally received, and generates the alternate driving data by matching this timing to the output start timing within one cycle of the waveform of the alternate driving data generated from the driving characteristics data.

Then, the safety circuit 110 stops the emitting of the LD 230 (step S212). Specifically, the state determiner 111 outputs the LD driving stopping signal to the LDD 220. The LDD 220 that receives the LD driving stopping signal stops the emitting of the LD 230 by outputting, to the LD 230, a driving current signal for stopping the emitting of the LD 230, regardless of the LD driving data received from the control circuit 210.

Then, the safety circuit 110 acquires the emission state data from the PD module 250 and determines whether the LD 230 is still emitting (step S213). This is because the laser continues to be emitted from the LD 230 for a short amount of time even after the LD driving stopping signal is output to the LDD 220.

When the LD 230 is still emitting (step S213; Yes), the safety circuit 110 outputs the alternate driving voltage signal on the basis of the values of the driving characteristics data stored in the memory 114 (step S214), and executes step S213.

When the LD 230 is OFF (not emitting) (step S213; No), the safety circuit 110 determines whether the rise/fall state information is rising (step S215). When the rise/fall state information is rising (step S215; Yes), the safety circuit 110 reduces the upper peak value and outputs the alternate driving voltage signal (step S216), and executes step S218. When the rise/fall state information is falling (step S215; No), the safety circuit 110 reduces the lower peak value and outputs the alternate driving voltage signal (step S217), and executes step S218). Note that a configuration is possible in which the reduction of the upper peak value in step S216 is performed every predetermined cycle instead of every cycle. Additionally, a configuration is possible in which the reduction of the lower peak value in step S217 is also performed every predetermined cycle instead of every cycle.

In step S218, the safety circuit 110 determines whether both the upper peak value and the lower peak value are less than a predetermined value. When not less than the predetermined value (step S218; No), step S215 is executed. When less than the predetermined value (step S218; Yes), the safety circuit 110 outputs 0V as the alternate driving voltage signal (step S219), and ends the data-interrupted time processing.

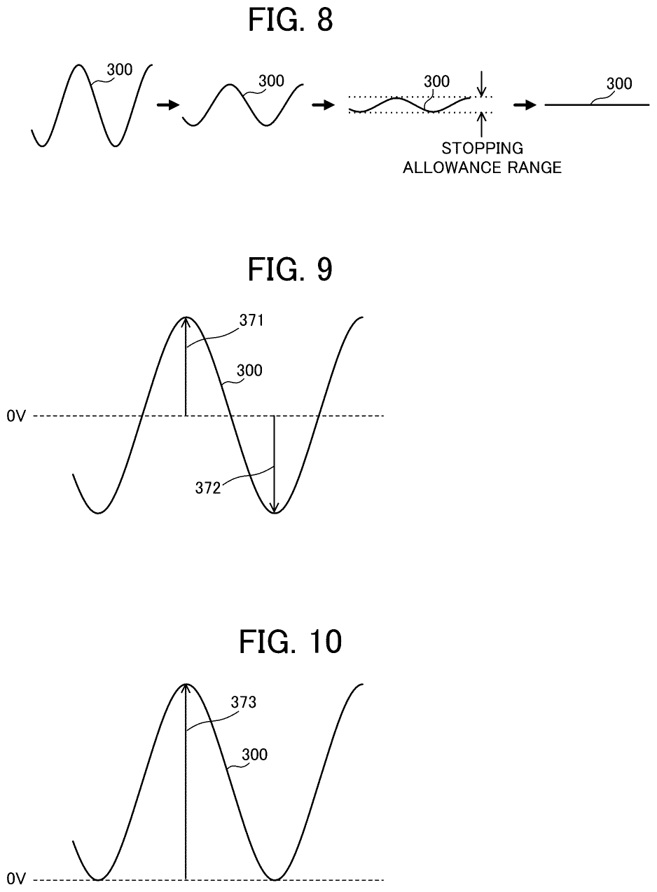

In the processing of steps S215 to S219, as a stopping sequence of the MEMS mirror, as illustrated in FIG. 8, the safety circuit 110 reduces the upper peak value and the lower peak value so that the magnitude of the amplitude of the waveform 300 of the alternate driving voltage signal gradually decreases every predetermined cycle in accordance with an amount of attenuation corresponding to the characteristics of the MEMS mirror (for example, the thickness, area, and the like of the MEMS mirror). When the magnitude of the amplitude is less than or equal to a stopping allowance range (that is, both the upper peak value and the lower peak value are less than the predetermined value), the amplitude is set to 0 (that is, 0V is output) and the MEMS mirror is stopped.

However, as described above, there are two types of driving of the MEMS mirror device 260, namely bipolar driving and unipolar driving. As such, in the case of bipolar driving, the absolute values of both the positive upper peak value 371 and the negative lower peak value 372 illustrated in FIG. 9 are reduced to approach 0V. In the case of unipolar driving, the positive upper peak value 373 illustrated in FIG. 10 is reduced to approach 0V. Note that here, “unipolar driving” is defined as “driving in which the driving voltage signal is always greater than or equal to 0V”, but unipolar driving in which the driving voltage signal is always less than or equal to 0V can also be considered and, in that case, the absolute value of the negative lower peak value is reduced to approach 0V.

Conventional devices are designed assuming that the MEMS driver that drives the MEMS mirror can reliably receive MEMS driving data from the control circuit. Consequently, problems may occur when an abnormal situation occurs such as the MEMS driver not being able to receive the MEMS driving data from the control circuit. However, as described above, with the MEMS driver 100, due to the data-interrupted time processing described above, the safety circuit 110 outputs the alternate driving voltage signal at a time of an abnormality and, as a result, the oscillating of the MEMS mirror is maintained. Due to this, it is possible to prevent sudden stopping of the oscillating of the MEMS mirror and also prevent the danger of causing harm to people in the vicinity and the like due to the emitting of the laser from the LD 230 remaining at a single point. Additionally, when the oscillating of the MEMS mirror suddenly stops, an unexpected load is applied to the actuator of the MEMS mirror, which may lead to a device failure such as a break, a disconnect, a short, or the like. As such, these types of device failures can be prevented by maintaining the oscillating of the MEMS mirror. Furthermore, by gradually reducing the amplitude of the reciprocating motion of the MEMS mirror after the laser output from the LD 230 is stopped, it is possible to safely stop the MEMS mirror without applying an excessive load to the MEMS mirror. Accordingly, even if an abnormal situation occurs such as not being able to receive the MEMS driving data, the MEMS driver 100 can avoid, to the greatest extent possible, the effects of the abnormal situation.

### Embodiment 2

In Embodiment 1, the driving data controller 112 stores the cycle counter values and the peak values of the MEMS driving data in the memory 114 as the driving characteristics data, and generates the alternate driving data from these values. Due to this, the amount of memory required to store the driving characteristics data can be reduced, but there are cases in which it is not possible to faithfully reproduce the waveform of the MEMS driving data. Next, Embodiment 2 is described. In Embodiment 2, one cycle of the MEMS driving data is stored in order to reproduce the waveform of the MEMS driving data as faithfully as possible.

As illustrated by the dashed line in FIG. 2, the driving data controller 112 according to Embodiment 2 stores one cycle of horizontal direction MEMS driving data (horizontal direction driving data of one cycle) and one cycle of vertical direction MEMS driving data (vertical direction driving data of one cycle) in the memory 114. Although not illustrated in the drawings, two memory banks (memory bank A and memory bank B) in which the horizontal direction driving data of one cycle is stored and two memory banks (memory bank A and memory bank B) in which the vertical direction driving data of one cycle is stored are provided independently in the memory 114. Moreover, a timing counter (initial value is the first address in the memory bank) is provided as a variable for specifying the address at which the MEMS driving data is stored in the memory bank. When storing the MEMS driving data in the storage bank, the two memory banks are alternatingly updated with one cycle of data each. As a result, it is guaranteed that one cycle of the MEMS driving data is completely stored in the memory bank that is not currently being updated.

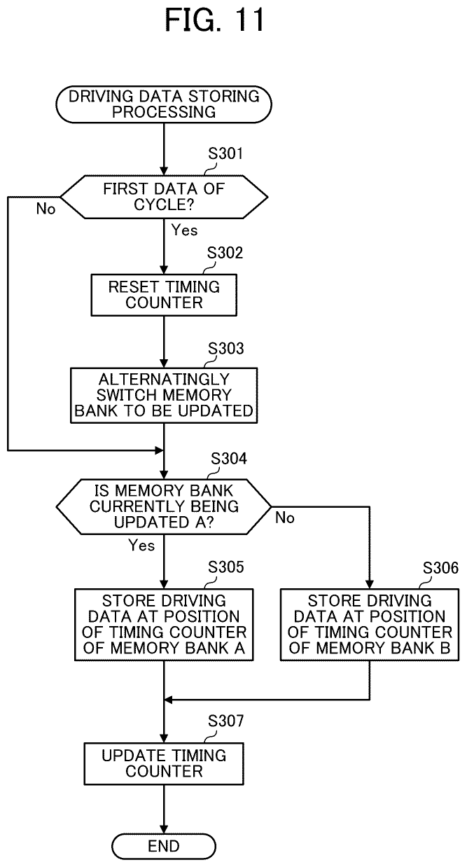

Next, driving data storing processing, that is processing whereby the driving data controller 112 stores one cycle of the MEMS driving data in the memory bank within the memory 114 is described while referencing FIG. 11. This processing is executed each time one piece of the MEMS driving data is received (that is, every sampling cycle of the MEMS driving data). However, as described above, since there are two types of MEMS driving data, namely horizontal direction MEMS driving data and vertical direction MEMS driving data, in actuality, each of two types of processing, namely driving data storing processing for storing the horizontal direction MEMS driving data (horizontal direction driving data storing processing) and driving data storing processing for storing the vertical direction MEMS driving data (vertical direction driving data storing processing) is executed.

Firstly, the safety circuit 110 determines whether the received MEMS driving data is the first data of the cycle (step S301). This determination can be made on the basis of whether it is the timing at which the rise/fall state information of the status information switches from rising to falling (or from falling to rising).

When the received MEMS driving data is the first data of the cycle (step S301; Yes), the timing counter is reset (step S302), the memory bank to be updated is alternatingly switched (to memory bank B if memory bank A was being updated, and to memory bank A if memory bank B was being updated) (step S303), and step S304 is executed.

When the received MEMS driving data is not the first data of the cycle (step S301; No), step S304 is executed.

In step S304, the safety circuit 110 determines whether the memory bank currently being updated is the memory bank A. When the memory bank currently being updated is the memory bank A (step S304; Yes), the safety circuit 110 stores the MEMS driving data at the position (address) of the timing counter of the memory bank A (step S305), and executes step S307.

When the memory bank currently being updated is not the memory bank A (step S304; No), the safety circuit 110 stores the MEMS driving data at the position (address) of the timing counter of the memory bank B (step S306), and executes step S307.

In step S307, the safety circuit 110 updates the timing counter (to the next address at which the MEMS driving data is to be written), and ends the driving data storing processing.

As a result of the driving data storing processing described above, one cycle of the MEMS driving data is stored in the memory 114.

In Embodiment 2, due to the driving data storing processing (FIG. 11), the MEMS driving data itself is stored in the memory 114 as the driving signal information and, as such, the need to execute the status information receiving processing (FIG. 5) of Embodiment 1 is eliminated. Additionally, although the timed-out time processing (FIG. 6) and the data-interrupted time processing (FIG. 7) are executed in Embodiment 2 as well, in step S211 of the data-interrupted time processing (FIG. 7), the driving data controller 112 ascertains the timing at which the data communication with the control circuit 210 became abnormal on the basis of the most recent MEMS driving data and rise/fall state information that was normally received, and generates the alternate driving data by matching this timing to the output start timing within one cycle of the waveform of the one cycle of MEMS driving data acquired by referencing the memory bank that is not currently being updated in the driving data storing processing (FIG. 11).

Aside for the features described above, the processing in Embodiment 2 is the same as the processing in Embodiment 1. In Embodiment 2, the amount of data that must be stored in the memory 114 is greater than that in Embodiment 1, but it is possible to bring the waveform of the driving voltage signal that drives the MEMS mirror device 260 closer to the waveform when normal. Even if an abnormality occurs in the data communication between the control circuit 210 and the MEMS driver 100, Embodiment 2 is effective in cases in which it is necessary to make the driving voltage signal that drives the MEMS mirror device 260 substantially the same as when normal.

### Modified Examples

Various embodiments have been described above, but the present disclosure can also be applied to any system in which a laser (regardless of being a visible light laser or a non-visible light laser) is caused to emit and a single MEMS mirror is caused to reflect the laser while being driven to scan the laser and perform irradiation.

For example, a configuration is possible in which a noise situation (for example, the signal-to-noise (SN) ratio) on a communication path between the control circuit 210 and the MEMS driver 100 is acquired and, instead of (or together with) the timed-out time processing described above, processing (reliability determination processing) for determining whether the effect of the noise is high and the reliability of the data is low (for example, whether the SN ratio is less than or equal to a predetermined reference value) is performed. Moreover, when a determination is made that the reliability of the data is low, the data-interrupted time processing described above is performed and the output source of the driving voltage signal is switched from the driving circuit 120 to the safety circuit 110 to prevent abnormal oscillating of the MEMS mirror caused by data corruption.

Additionally, a configuration is possible in which an error detection symbol is added to the data used in the communication between the control circuit 210 and the MEMS driver 100 and, instead of (or together with) the timed-out time processing, processing (error detection processing) for detecting whether there is an error in the data is performed. Moreover, when an error is detected in the data, the data-interrupted time processing described above is performed and the output source of the driving voltage signal is switched from the driving circuit 120 during the execution safety circuit 110 to prevent abnormal oscillating of the MEMS mirror caused by data corruption.

In the embodiments described above, the MEMS mirror device 260 is a voltage-driven device that includes a MEMS mirror that is oscillated by an actuator constituted by a piezoelectric element, and the driving signal is a driving voltage signal, but the MEMS mirror device 260 is not limited to a voltage-driven device. For example, when the MEMS mirror device 260 is a current-driven device, a configuration is possible in which the safety circuit 110 and the driving circuit 120 generate, as the driving signal, a driving current signal from the MEMS driving data and output the generated driving current signal.

Additionally, in the data-interrupted time processing (FIG. 7) described above, in step S212, it is assumed that, after the state determiner 111 outputs the LD driving stopping signal to the LDD 220, the emitting of the LD 230 definitely stops, but it is possible that the emitting of the LD 230 does not stop due to some cause (for example, a disconnect of the signal line over which the LD driving stopping signal is output from the safety circuit 110 to the LDD 220). In preparation for such a case, a configuration is possible in which the timer is caused to count within the loop of steps S213 to S214 of the data-interrupted time processing (FIG. 7) and, when the LD 230 continues to emit even though a predetermined amount of time (for example, five seconds) has elapsed, a message informing the user of an abnormality (for example, lighting of an error display LED; outputting of an error sound; audio guidance such as “An internal circuit communication error has occurred. An attempt has been made to stop the emitting of the laser, but the emission could not be stopped. Turn off the power to the device and contact the manufacturer for support.”; or the like) is output.

Note that the control flow in all of the various processings described above is simple and, as such, the MEMS driver 100 (the MEMS mirror driving circuit) can be realized as a digital circuit written in a hardware description language such as Verilog Hardware Description Language (VHDL). However, it is not necessary to realize all of the processings executed by the MEMS driver 100 as digital circuits. For example, a configuration is possible in which the MEMS driver 100 includes a processor such as a central processing unit (CPU) or the like, and the processor executes a program to execute some or all of the various processings described above.

Examples of uses of the scanning projection system 1000 described in the various embodiments described above include a laser scanning projection device on which a MEMS scanning mirror device is mounted, a laser scanning illumination device on which a MEMS scanning mirror device is mounted, and the like.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A MEMS mirror driving circuit comprising:
a driving circuit that receives MEMS driving data from a control circuit and outputs, to a MEMS mirror device, a driving signal generated based on the MEMS driving data; and
a safety circuit that receives status information and the MEMS driving data from the control circuit and determines whether data communication with the control circuit is normal, in a case in which the data communication is normal, acquires driving signal information for generating, based on the status information and the MEMS driving data, an alternate driving signal that serves as an alternative to the driving signal and, in a case in which the data communication is not normal, outputs, instead of the driving signal, the alternate driving signal generated based on the driving signal information to the MEMS mirror device.

2. The MEMS mirror driving circuit according to claim 1, wherein the status information includes rise/fall state information indicating a rise/fall state of a value of the MEMS driving data.

3. The MEMS mirror driving circuit according to claim 2, wherein
the safety circuit
acquires, based on the rise/fall state information and as the driving signal information, a rise period that is a period in which the value of the MEMS driving data is rising and a fall period that is a period in which the value of the MEMS driving data is falling, and
generates the alternate driving signal based on a timing at which the data communication with the control circuit becomes not normal, and the rise period and the fall period.

4. The MEMS mirror driving circuit according to claim 2, wherein
the safety circuit
acquires, based on the rise/fall state information and the MEMS driving data, and as the driving signal information, driving data of one cycle that is data of the MEMS driving data of one cycle, and
generates the alternate driving signal based on a timing at which the data communication with the control circuit becomes not normal, and the driving data of one cycle.

5. The MEMS mirror driving circuit according to claim 3, wherein
the safety circuit
receives emission state data indicating an emission state of a light source, and
in a case in which the emission state data is OFF,
gradually reduces an amplitude of the alternate driving signal to zero every predetermined cycle, in accordance with an amount of attenuation corresponding to a characteristic of a MEMS mirror of the MEMS mirror device.

6. The MEMS mirror driving circuit according to claim 4, wherein
the safety circuit
receives emission state data indicating an emission state of a light source, and
in a case in which the emission state data is OFF,
gradually reduces an amplitude of the alternate driving signal to zero every predetermined cycle, in accordance with an amount of attenuation corresponding to a characteristic of a MEMS mirror of the MEMS mirror device.

7. A scanning projection system comprising:
a light source that radiates light;
a MEMS mirror device including a MEMS mirror that reflects the light radiated from the light source to illuminate a projection surface, and an actuator that causes the MEMS mirror to oscillate;
a control circuit that outputs MEMS driving data for generating a driving signal that drives the actuator; and
a MEMS mirror driving circuit that receives the MEMS driving data from the control circuit and outputs the driving signal, wherein
the MEMS mirror driving circuit includes
a driving circuit that receives the MEMS driving data from the control circuit and outputs, to the MEMS mirror device, the driving signal generated based on the MEMS driving data; and
a safety circuit that receives status information and the MEMS driving data from the control circuit and determines whether data communication with the control circuit is normal, in a case in which the data communication is normal, acquires driving signal information for generating, based on the status information and the MEMS driving data, an alternate driving signal that serves as an alternative to the driving signal and, in a case in which the data communication is not normal, outputs, instead of the driving signal, the alternate driving signal generated based on the driving signal information to the MEMS mirror device.

8. A MEMS mirror driving method comprising:
receiving status information and MEMS driving data from a control circuit and determining whether data communication with the control circuit is normal;
in cases in which the data communication is normal, outputting a driving signal generated based on the MEMS driving data to a MEMS mirror device, and acquiring driving signal information for generating, based on the status information and the MEMS driving data, an alternate driving signal that serves as an alternative to the driving signal; and
in cases in which the data communication is not normal, outputting, instead of the driving signal, the alternate driving signal generated based on the driving signal information to the MEMS mirror device.
